(19) United States
(12) Patent Application Publication
(10) Pub. No.: US 2003/0060527 A1
(43) Pub. Date: Mar. 27, 2003

(54) Hemo-and biocompatible polymeric adsorbing material for purification of physiological fluids of organism, and a method of producing the material, and a method of and device for purification of physiological fluids of organism with the use of the material

(76) Inventors: Vadim Davankov, Moscow (RU); Ludmila Pavlova, Moscow (RU); Peter Quartararo, New York, NY (US); Maria Tsyurupa, Moscow (RU)

Correspondence Address: Ilya Zborovsky, 6 Schoolhouse Way, Dix Hills, NY, 11746, US

(21) Appl. No.: 09/953,755

(22) Filed: Sep. 17, 2001

(51) Int. Cl. C08L 63/00

(52) U.S. Cl. 521/134; 525/332.2; 521/142; 530/413; 210/502.1

(57) ABSTRACT

A hemo- and biocompatible polymeric adsorbing material for purification of physiological fluids of an organism has a plurality of beads, each having a core having hydrophobic properties and a plurality of pores, and a coating having a hydrophilic, hemo- and bicompatible property applied on a surface of the core and occupying about 20%-90% of the surface of the core so as to form on the surface of the core alternating portions of the hydrophilic hemo- and biocompatible coating and portions of hydrophobic core which are not covered with the coating. A method of producing the material includes the selective coating of the surface of the core. A device for and a method of purification of physiological fluids of organism includes the use of the new material.

### BACKGROUND OF THE INVENTION

The present invention relates to biocompatible and hemocompatible polymeric adsorbents having a hydrophobic porous interior and a hydrophilic outer covering, as well as to methods of preparing the adsorbents and also to methods of and devices for purification of the physiological fluids of an organism using the adsorbents.

Porous hydrophobic natural and polymeric materials, in particular, activated carbon and polymeric resins are widely used in numerous adsorption technologies. They represent a good choice for purifying blood or other physiological fluids of an organism from many endogenic and exogenic toxic organic compounds. However, the hydrophobic nature of these materials can cause activation of multiple components of blood including the compliment and clotting systems and platelets. Therefore, in procedures for the purification of the physiological fluids of organism, only surface modified particles of the adsorbents can be employed. The modification is performed by forming a surface layer or coating of a hydrophilic biocompatible material, which serves, to however decrease the rate of diffusion of toxins into the interior of the adsorbent particle.

Materials which have a hydrophobic interior or core and hydrophilic biocompatible coating or shell are disclosed for example in U.S. Pat. Nos. 4,410,652; 4,202,775; 5,773,384; 5,904,663; 6,087,300; 6,114,466; and 6,127,311. The application of the coating on the surface of the core of the beads of the material is performed by various methods which involve the formation of a hydrophilic biocompatible shell and its retention on the surface of the core. Despite what appears to be the highly beneficial results described in the prior art, It is believed that further improvements can be made.

### SUMMARY OF THE INVENTION

Accordingly, it is an object of the present invention to provide a hemo- and biocompatible polymeric adsorbing material, a method of producing the material, as well as a device and a method of purification of physiological fluids of organism with the use of the material, which provide further improvements over existing solutions.

In keeping with these objects and with others which will become apparent hereinafter, one feature of present invention resides, briefly stated, in a hemo- and biocompatible polymeric adsorbing material which includes a plurality of beads each having a core with hydrophobic properties and having a plurality of pores, and a coating with hydrophilic hemo- and biocompatible properties applied on an external surface of the core, wherein the coating is composed of a plurality of coating portions which are spaced from one another so as to retain hydrophobic surface portions on the external surface of the core which are not occupied by the hydrophilic coating portions, and the coating occupies about 20-90% of the outer surface of the core. This pattern of the coating is applied exclusively to the surface of the core of the beads, while the interior of the core remains unchanged.

In accordance with another feature of present invention, a method of making a hemo- and biocompatible polymeric adsorbing material is proposed which includes the steps of forming a plurality of beads each having a core with hydrophobic properties and having a plurality of pores, and applying a coating with hydrophilic hemo- and biocompatible properties on an external surface of the core with a plurality of coating portions which are spaced from one another so as to retain hydrophobic surface portions on the surface of the core which are not occupied by the hydrophillic coating portions, and the coating occupies about 20-90% of the surface of the core.

Still another feature of present invention is a method of purification of physiological fluids of organism, in accordance with which a physiological fluid of organism is passed through a material which has a plurality of beads each having a core with hydrophobic properties and having a plurality of pores, and a coating with hydrophilic hemo- and biocompatible properties applied on an external surface of the core, wherein the coating is composed of a plurality of coating portions which are spaced from one another so as to retain hydrophobic surface portions on the surface of the core which are not occupied by the hydrophilic coating portions, and the coating occupies about 20-90% of the surface of the core.

Finally, it is another feature of present invention to provide a device for purification of physiological fluids of organism which includes a housing with an inlet for introducing a physiological fluid to be purified, an outlet for withdrawing the purified physiological fluid, and in the housing a body of a hemo- and biocompatible polymeric adsorbing material which is composed of a plurality of beads each having a core with hydrophobic properties and having a plurality of pores, and a coating with hydrophilic hemo- and biocompatible properties applied on an external surface of the core, wherein the coating is composed of a plurality of coating portions which are spaced from one another so as to retain hydrophobic portions on the surface of the core which are not occupied by the hydrophilic coating portions, and the coating occupies about 20-90% of the surface of the core.

When the hemo- and biocompatible polymeric adsorbing material is formed and the method of making the material is performed in accordance with the present invention, then the hydrophilic hemo- and biocompatible coating can be selected to exclusively provide the hemo- and biocompatibility of the beads to maintain the blood complement system, to avoid activation, to prevent deposition of platelets, and to forestall clot formation. The remaining uncoated hydrophobic surface of the beads is provided exclusively for acceleration of adsorption of toxins from the physiological fluids of organism.

In a surprising and unobvious manner, it has been found that when the surface of the core of the beads is coated about 20%-90% with a hydrophilic hemo- and biocompatible coating, an excellent hemocompatibility, and biocompatibility of the adsorbing material are achieved, as well as achieving highly-efficient adsorption capacity and improved kinetic properties.

The novel features which are considered as characteristic for the present invention are set forth in particular in the appended claims.

### BRIEF DESCRIPTION OF THE DRAWINGS

FIG. 1 is a view illustrating a canine test, showing the response of platelets to passage of blood through the inventive material in due time; and

FIG. 2 is a view schematically showing a surface of a bead of the inventive hemo- and biocompatible polymeric adsorbing material.

### DESCRIPTION OF THE PREFERRED EMBODIMENTS

In accordance with the present invention, a hemo- and biocompatible adsorbing material for purification of physiological fluids of organisms is proposed. Preferably, the porosity of the material is selected so as to remove toxic compounds in the range of molecular weights of about 300 to 40,000 Dalton from the physiological fluid.

In accordance with the present invention, the hemo- and biocompatible polymeric material has a plurality of beads each having a core with hydrophobic properties and having a plurality of pores, and a coating with hydrophilic hemocompatible and biocompatible properties applied on a surface of the core. The coating is composed of a plurality of coating portions which are spaced from one another so as to retain hydrophobic surface portions on the surface of the core which are not occupied by the hydrophilic coating portions.

In accordance with the invention, the hydrophilic hemo- and biocompatible coating occupies about 20%-90% of the surface of the core, and the remaining portion of the surface of the core is not coated with the hydrophilic hemo- and biocompatible coating and remains hydrophobic.

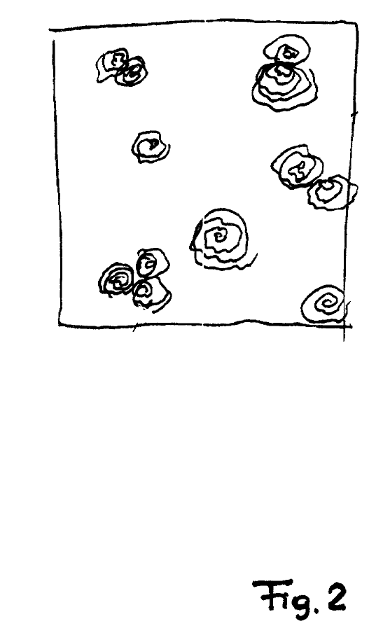

As shown in FIG. 2, the hydrophilic hemo- and biocompatible coating portions 1 and the non-coated hydrophobic portions 2 of the core can be arranged in a mosaic pattern, so that they are located in alternative order.

The degree of surface coverage provided by the hemo- and biocompatible coating can be selected to be optimal for corresponding applications. In emergency situations it is preferable to cover about 20-25% of the surface of the core with the hemo- and biocompatible coating, so that 80-75% of the surface of the core remains hydrophobic and provides a high speed of toxin removal from the physiological fluid. For patients who are not in emergency situations, but have high quantity of toxins, for example beta-2 microglobulin, it is recommended to use the material in which about 25%-55% of the surface of the core of the beads is covered with the hemo- and biocompatible coating. For chronic patients, where the highest degree of hemo- and biocompatibility is important, it is recommended to use a material with a hemo- and biocompatible coating which covers about 55-90% of the surface of the core of the beads.

As an example of the material in accordance with the present invention, a porous hydrophobic divinylbenzene copolymer is utilized which initially has surface exposed vinyl groups. Thereafter, the vinyl groups are chemically modified, so as to form a coating composed of different surface exposed functional groups which are hydrophilic and hemo- and biocompatible. The coating can be formed for example by grafting of hydrophilic polymer chains, by radical polymerization of water soluble monomors, by oxidation of the vinyl groups to other groups with subsequent reaction of the other groups with further substances, by depositing of high-molecular weight hemo- and biocompatible polymers, etc.

In the following examples a mesoporous divinylbenzene-styrene copolymer, a typical polystyrene-type adsorbing material and a copolymer of the divinylbenzene with butylmetacrylate with surface exposed double bonds were employed for the modification.

The surface modified materials exhibit good hemocompatibility, i.e. they do not noticeably change the coagulation time of blood, cause no hemolysis and show no cytotoxicity effects. When contacted with plasma or whole blood, the materials effectively remove the pool of middle-size molecules, as can be easily ascertained by conventional spectral measurements.

In all cases, the hydrophilic hemo- and biocompatible coating was selected to cover about 20%-90% of the surface of the core of the beads.

### EXAMPLE 1

Into a seven-liter four-necked round-bottom flask equipped with a stirrer, a thermometer and a reflux condenser, was placed a solution of 8.4 g polyvinyl alcohol-type technical grade emulsion stabilizer GM-14 in four liters of deionized water (aqueous phase). A solution of 260 ml divinylbenzene, 140 ml ethylvinylbenzene, 250 ml toluene, 250 ml n-octane and 2.94 g benzoyl peroxide (organic phase) was then added to the aqueous phase with stirring at room temperature. In 20 min, the temperature was raised to 80° C. The reaction was carried out at 80° C. for 8 hours and 90-92° C. for an additional 2 hours. After accomplishing the copolymerization, the stabilizer was rigorously washed out with hot water (60 to 80° C.). The liquid was removed from the reactor and a solution of 5 g Trisodium phosphate in 1.8 L water was added. When the temperature was raised to 80° C., a solution of 8.2 g of ammonium persulfate in 40 ml water was added and in a few minutes a solution of 0.6 ml of N-vinyl-2-pyrrolidone in 60 ml H₂O was introduced. The reaction continued for 3 hours at 70° C. with stirring. After completing the reaction the polymer was washed with water and the above organic solvents were removed by steam distillation. The beads obtained were filtered, washed with 1 L dioxane and with deionized water. Finally, the beads were dried in an oven over night at 60° C.

The polymer obtained in Example 1, had the following properties:

1. displayed apparent inner surface area of 1200 sq.m/g and total pore volume of 0.8 ml/g;

2. increased its volume in ethanol by a factor of 1.3;

3. degree of surface coating was 50%;

4. efficiently removed beta2-microglobulin from the blood of patients on chronic dialysis treatment; and

5. successfully passed the hemocompatibility test (recalcification of plasma within the allowed 126-144 sec time limits).

### EXAMPLE 2

7.2 L of water were placed in a 14 L glass vessel equipped with a stirrer and a reflux condenser and heated to 80° C. When the temperature reached 60° C., 13.0 g of a stabilizer, AIRVOL 523, was added. The stabilizer was dissolved within 40 min on stirring. Then, 9.1 g of monosodium phosphate, 30.3 g of disodium phosphate, 17.3 g of trisodium phosphate, 47.0 g of sodium chloride and 100 mg of sodium nitrite were added. After complete dissolution of the chemicals, a solution of 11.1 g of benzoyl peroxide in 1720 ml of 55% divinylbenzene, 1600 ml of iso-octane and 1120 ml of toluene, was dispersed in the above aqueous phase. Following 12 hours at 80° C. with stirring, the temperature was lowered to 40° C. and a solution of 26.2 g ammonium persulfate in 100 ml of water was added. After several minutes, 35 ml of tetramethyl ethylene diamine were introduced and afterwards a solution of 3.2 ml of N-vinyl-2-pyrrolidone in 200 ml of water was added. The grafting was carried out for 1.5 hours at 40° C. Upon completing the reaction, the beads were washed rigorously with hot water, methanol and cold water. The beads were filtered off and dried in an oven at 60 to 80° C. The polymer was wetted with water. The degree of surface coating was 20%.

TABLE 1
Beads size 500-600 micron, 0.05 molar phosphate buffer, 37° C.
15 ml of 0.5 mg/ml cytochrome C solution, polymer sample 230 mg

| Time | Sorption |
|---|---|
| (hrs) | (mg/g) dry polymer |
| 0.5 | 77.2 |
| 1 | 87.7 |
| 1.5 | 100.1 |
| 2 | 103.4 |
| 3 | 112.1 |

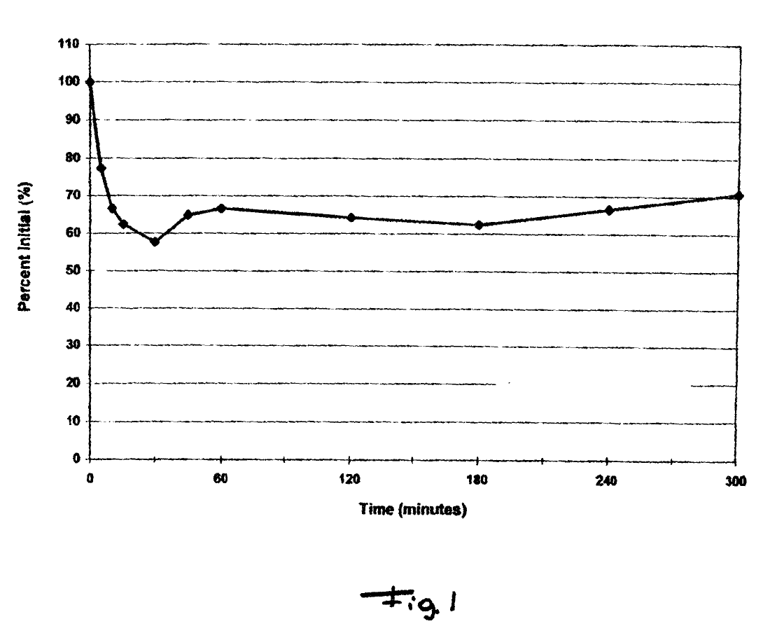

Table 1 illustrates the high rate of diffusion and high adsorption capacity for cytochrome C on this polymer while FIG. 1 shows a sufficient hemocompatibility of the latter, namely, the reduction of platelets in the canine experiment does not exceed 43%.

### EXAMPLE 3

7.2 L of water were placed in a 14 L glass vessel equipped with a stirrer and a reflux condenser and heated to 80° C. When the temperature reached 60° C., 13.0 g of a stabilizer, AIRVOL 523, was added. The stabilizer was dissolved within 40 min on stirring. Then 14.0 g of monosodium phosphate, 46.8 g of disodium phosphate, 28.7 g of trisodium phosphate, 72 g of sodium chloride and 150 mg of sodium nitrite were added. After complete dissolution of the chemicals, a solution of 11.1 g of benzoyl peroxide in 1500 ml of trivinylbenzene, 1000 ml of iso-octane and 1000 ml of toluene was dispersed in the above aqueous phase. Following 3 hours of stirring at 80° C., a solution of 8.2 ml of N-vinyl-2-pyrrolidone in 200 ml of water was added. A polymerization was then carried out for 9 hours at 80° C. Upon completing the reaction, the beads were washed rigorously with hot water, methanol and cold water. The beads were filtered off and dried in an oven at 60 to 80° C. The inner surface area of the polymer was 900 m² μg. The polymer was wetted with water. The degree of surface coating was 70-75%.

### EXAMPLE 4

### Example 4

5 L of water were placed in a 14 L glass vessel equipped with a stirrer and a reflux condenser and heated to 80° C. When the temperature reached 60° C., 15.5 g of a stabilizer, AIRVOL 523, was added. The stabilizer was dissolved within 40 min on stirring. Then 20 g of sodium carbonate and 300 mg of sodium nitrite were added. After complete dissolution of the chemicals, a solution of 20 g of benzoyl peroxide in 1000 ml of buthyl methacrylate, 700 ml of 63% divinylbenzene, and 1250 ml of toluene was dispersed in the above aqueous phase. Following 2 hours of stirring at 80° C., a solution of 19 g of 2-hydroxyethylmethacrylate in 100 ml of water was added. The polymerization was carried out for 9 hours at 80° C. Upon completing the reaction, the beads were washed rigorously with hot water, methanol and cold water. The beads were filtered off and dried in oven at 60 to 80° C. The polymer was wetted with water.

In order to insure that about 20% to about 90% of the surface of the core of the beads is covered by the coating, calculations were made to determine the total surface of the beads, and the quantity of the material for coating the surface of the beads was selected correspondingly (Examples for 90%, 70%, 50%, 20%).

The total outer surface of 100 g of beads having a diameter of 0.5 mm (0.05 cm) was calculated as:

The outer surface of 1 bead:

S₁=4πR²=4·3.14·0.05²=0.00785 cm²

where R is the radius of the bead.

The volume of 1 bead:

$$V = \frac{4}{3} π {R}^{3} = 4 / 3 \cdot 3.14 \cdot {0.05}^{3} = 0.000065 {cm}^{3}$$

The density of polymer is 1 g/cm³. Thus, 100 g of beads have a volume of 100 cm³.

The number of beads in 100 g (100 cm³) of the polymer:

$$\frac{100}{6.5 \cdot {10}^{- 5}} = 1.5 \cdot {10}^{6}$$

The outer surface of 100 g beads is 1.5·10⁶·0.00 785=12000 cm².

The surface area is determined by nitrogen adsorption at −196° C.

In accordance with the present invention, a device for purification of physiological fluids is also proposed. The device has a housing having an inlet for introducing a physiological fluid into the housing to be purified, and an outlet for withdrawing the purified physiological fluid; and in the housing a body of hemo- and biocompatible material comprised of beads each having a core hydrophobic and a plurality of pores; and a hydrophilic coating having hemo- and biocompatible properties applied on a surface of the core and occupying about 20% to about 90% of the surface of the core so as to form on the surface of the core a plurality of portions of the hydrophilic hemo- and biocompatible coating, with portions of hydrophobic core which are not covered with the coating located therebetween.

In accordance with the present invention, a method for the purification of the physiological fluids of an organism is contemplated. The method includes passing a physiological fluid through a material comprised of beads each having a hydrophobic core with a plurality of pores; and a coating having hydrophilic hemo- and biocompatible properties applied on a surface of the core and occupying about 20%-90% of the surface of the core so as to form on the surface of the core portions of the hydrophilic hemo- and biocompatible coating, with portions of hydrophobic core which are not covered with the coating located therebetween.

It will be understood that each of the elements described above, or two or more together, may also find a useful application in other types of materials, methods and constructions differing from the types described above.

While the invention has been illustrated and described as embodied in a hemo- and biocompatible polymeric adsorbing material for purification of the physiological fluids of an organism, and a method of producing the material, and a method of and device for purification of physiological fluids of an organism with the use of the material, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A hemo- and biocompatible polymeric adsorbing material for purification of physiological fluids of an organism, comprising a plurality of beads each having a generally hydrophobic core with a plurality of pores; and a coating having hydrophilic, hemo- and bicompatible properties and applied on a surface of the core and occupying about 20-90% of the surface of the core to form on the surface of the core alternating portions of the hydrophilic hemo- and biocompatible coating and portions of hydrophobic core which are not covered with the coating.

2. A hemo- and biocompatible polymeric adsorbing material as defined in claim 1, wherein said hydrophilic hemo- and biocompatible coating occupies about 20-25% of the surface of the core.

3. A hemo- and biocompatible polymeric adsorbing material as defined in claim 1, wherein said hydrophilic hemo- and biocompatible coating occupies about 25-55% of the surface of the core.

4. A hemo- and biocompatible polymeric adsorbing material as defined in claim 1, wherein said hydrophilic hemo- and biocompatible coating occupies about 55-90% of the surface of the core.

5. A method of producing a material for the purification of the physiological fluids of an organism comprised of a plurality of beads, comprising the steps of forming for each bead a generally hydrophobic core with a plurality of pores; and applying on a surface of the core a coating having a hydrophilic, hemo- and bicompatible properties and occupying about 20%-90% of the surface of the core so as to form on the surface of the core alternating portions of the hydrophilic hemo- and biocompatible coating and portions of hydrophobic core which are not covered with the coating.

6. A method as defined in claim 5; and further comprising applying said coating on about 20-25% of the surface of the core.

7. A method as defined in claim 5; and further comprising applying said coating on about 25-55% of the surface of the core.

8. A method as defined in claim 5; and further comprising applying said coating on about 55-90% of the surface of the core.

9. A device for the purification of physiological fluids of an organism, comprising a housing having an inlet for introducing a physiological fluid into said housing to be purified, and an outlet for withdrawing the purified physiological fluid; and in the housing a body of biocompatible material composed of a plurality of beads each having a hydrophobic core with a plurality of pores; and a coating having hydrophilic, hemo- and bicompatible properties and applied on about 20%-90% of a surface of the core to form on the surface of the core alternating portions of the hydrophilic hemo- and biocompatible coating and portions of hydrophobic core which are not covered with the coating.

10. A method for purification of the physiological fluids of an organism, comprising passing a physiological fluid through a material composed of a plurality of beads, each having hydrophobic core and a plurality of pores; and a coating having a hydrophilic, hemo- and bicompatible properties and applied on about 20%-90% of a surface of the core to form on the surface of the core alternating portions of the hydrophilic, hemo- and biocompatible coating and portions of hydrophobic core which are not covered with the coating.
